(19) United States
(12) Patent Application Publication
(10) Pub. No.: US 2004/0217587 A1
(43) Pub. Date: Nov. 4, 2004

(54) Miniature tube compression seal

(76) Inventors: Dominic F. Gervasio, Fountain Hills, AZ (US); Sonja Tasic, Gilbert, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/428,174

(22) Filed: Apr. 30, 2003

(51) Int. Cl. F16L 39/00

(52) U.S. Cl. 285/125.1

(57) ABSTRACT

An exemplary system and method for providing a substantially adhesive-free seal and miniature tube, is disclosed as comprising inter alia: a microfluidic substrate (200) with fluidic channels (220) defined therein; a tube seal recess (210) in fluid communication with the channels (220); a flanged tube seal (225) for engagement with the recess (210); and a cover plate (240) with an opening (255) defined therein to permit the tube seal (225) to protrude therethrough. Disclosed features and specifications may be variously controlled, adapted or otherwise optionally modified to improve sealing and/or flow operation in any fluid transport application. Exemplary embodiments of the present invention representatively provide for efficient transport of fluids over a relatively broad range of temperatures and pressures that may be readily integrated with existing micro-scale technologies for the improvement of device package form factors, weights and other manufacturing and/or device performance metrics.

### FIELD OF INVENTION

The present invention generally concerns systems and methods for facilitating fluid transportation over a relatively broad range of temperatures and/or pressures; and more particularly, in various representative and exemplary embodiments, to a micro-scale device for providing a substantially adhesive-free seal and fluid transport path in a microfluidic device.

### BACKGROUND

Epoxy, glue and/or other adhesives are conventionally used to positionally fix miniature tubes in microfluidic devices. During operation, under high fluid pressure and/or temperature, the adhesive material may break down, thereby contaminating the fluid stream with potentially undesirable chemicals. Such contamination is particularly relevant, for example, to catalyst poisoning in microfluidic fuel cell applications. Accordingly, improved performance and other device metrics may be obtained with the provision of a substantially adhesive-free system and method for sealing and positionally fixing miniature tubes for use with microfluidic devices.

### SUMMARY OF THE INVENTION

In various representative aspects, the present invention provides a system and method for the substantially adhesive-free sealing of miniature tubes in microfluidic applications. An exemplary system and method for providing such a device is disclosed as comprising inter alia: a microfluidic substrate with fluid channels defined therein; a tube seal recess in fluid communication with the channels; an substantially integrated flanged seal and miniature tube for engagement with the recess; and a cover plate with an opening defined therein to permit the miniature tube to protrude therethrough. Fabrication of the disclosed devices is relatively simple, inexpensive and straightforward. Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 representatively depicts a flanged seal tube in accordance with an exemplary embodiment of the present invention;

FIG. 2 generally illustrates an exploded view of a ceramic device employing a flanged seal tube in accordance with the device representatively depicted in FIG. 1; and

FIG. 3 generally illustrates a cross-sectional side view of the ceramic device representatively depicted in FIG. 2.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms ‘front’, ‘back’, ‘top’, ‘bottom’, ‘over’, ‘under’, and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF EXEMPLARY EMBODIMENTS

The following descriptions are of exemplary embodiments of the invention and the inventors' conceptions of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely a system and method for substantially adhesive-free sealing of a miniature tube in a microfluidic device, is provided as a specific enabling disclosure that may be readily generalized by skilled artisans to any application of the disclosed system and method for adhesive-free compression sealing in accordance with various embodiments of the present invention.

In one representative and exemplary embodiment, the present invention discloses a method for sealing a small fluid-conducting tube into a microfluidic ceramic housing without the use of adhesives so that the fluid may be contained and kept substantially free from chemical leaching or other contamination at low (about −50° C.) to high temperatures (over about 300° C.) and from partial vacuum (as low as about −1 atm) to elevated pressures (as high as about 3 atm). Such a system and method may be particularly useful for fuel cells, especially elevated temperature fuel cells which generally require that the fluid feeds be substantially pure in order to avoid fuel cell deactivation.

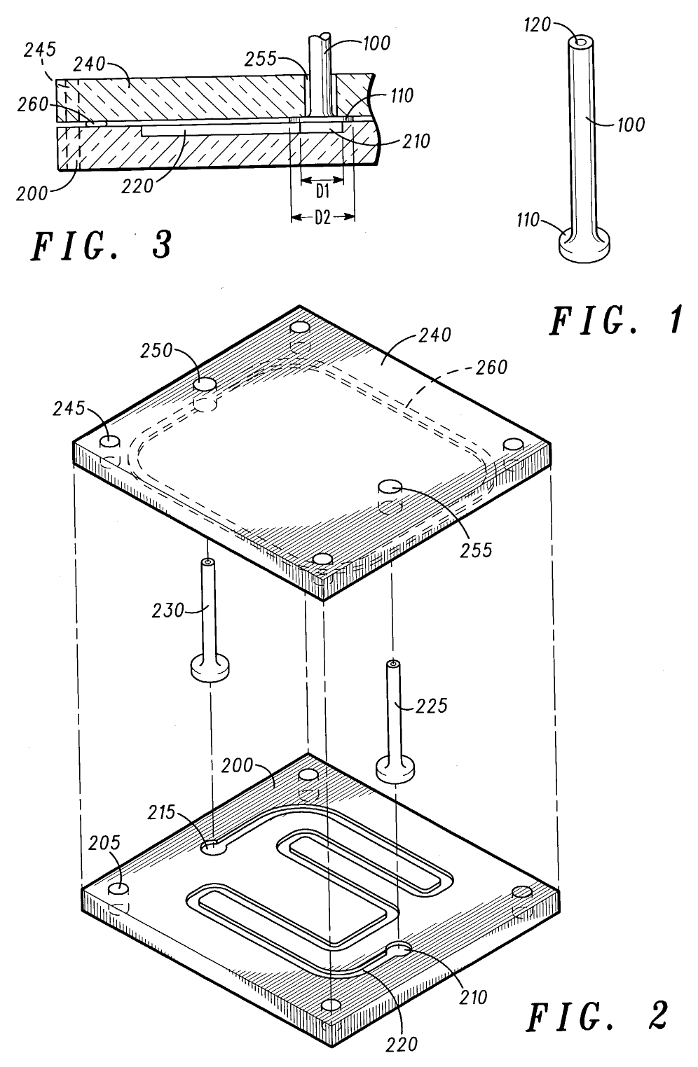

As generally depicted, for example, in FIG. 1, a tube 100 with an enlarged or flanged end 110 is suitably adapted for receipt of the distal end 120 of tube 100 through an opening of a cover plate in order to provide for compression sealing against a microfluidic substrate. This generally permits a fluid delivery tube 100 to be joined to, for example, a ceramic housed flow field without the use of adhesives but by means of a compression-type seal. Accordingly, such a device and method provides a substantially contamination free seal between the tube 100 and the substrate for admitting and removing gas, liquids and/or other fluids through vias corresponding to the inlet and outlet, for example, of a ceramic housed flow field, thereby permitting substantially contamination-free and steady fluid flow over a broad range of temperatures and pressures.

As generally illustrated, for example, in FIG. 2, a tube 100 for passing fluid through a substrate flow field 220 may be sealed by compression fitting of the flange/enlargement 110 against a cover plate 240. The tube 100 has an enlarged or flanged terminal portion 110 and the flange/enlargement 110 is received in a grove or recess 210 of the flow field substrate. In another exemplary embodiment of the present invention, the diameter D2 of the flanged portion and the inner diameter of tube 100 at least partially overlaps the diameter D1 of via 220 of the flow field. Two such tubes 225, 235 may be provided for receipt within receiving recesses 210, 215 respectively in order to provide a fluid inlet and fluid outlet for flow field 220. Cover plate 240 is generally configured with openings 255, 250 to permit tubes 225, 235 to pass through so as to provide fluid receipt and/or deliver to an external environment.

The tubes 225, 230 seal into the flow field substrate 200 when the cover plate 240 is affixed over the substrate 200; thereby trapping the flange/enlargement 110 and compressing the flange/enlargement 110 and/or any gasket that may be used in order to seal the flange/enlargement 110 to the substrate 200. As generally depicted in FIG. 2, for example, openings 205 may be defined through portions of said substrate 200 that are suitably adapted for alignment with openings 245 defined through portions of said cover 240 in order to facilitate, for example, bolt and nut engagement of the substrate 200 with cover 240. Skilled artisans, however, will appreciate that various other methods may be used to attached the cover plate 240 to substrate 200 in order to achieve a substantially similar result.

The periphery of the substrate 200 and cover 240 may optionally be sealed using, for example, a gasket 260. To make the tube 100 seal into the inlet or outlet of the flow field 220 in the substrate 200, the thickness of the flange/enlargement 110 and/or any gasket used with the flange/enlargement 110 generally should be about 10% or thicker than any peripheral gasket. In certain exemplary embodiments, suitably adapted tubes have been manufactured using Teflon tubing with a flanged end; however, skilled artisans will appreciate that any other materials, whether now known or hereafter discovered or otherwise described in the art, may be used as well.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

We claim:

1. A substantially self-sealing microfluidic device, said device comprising a miniature tube, said tube having an at least partially at least one of flanged and enlarged terminal portion.

2. The microfluidic device of claim 1, wherein said tube comprises at least one of a polymeric material and silicon.

3. The microfluidic device of claim 1, wherein said microfluidic device is employed as a component of a fuel cell device.

4. A miniature tube for passing a fluid through a flow field, said tube comprising an at least partially flanged terminal portion.

5. The miniature tube of claim 4, wherein said tube comprises at least one of a polymeric material and silicon.

6. The miniature tube of claim 4, wherein said tube comprises a substantially integrated component of a fuel cell device.

7. A method for passing fluid through a flow field, said method comprising the steps of:
providing a substrate, said substrate comprising a fluid flow field, said substrate further comprising a recess in fluidic communication with said flow field, said recess suitably adapted for receiving a miniature tube according to claim 1;
providing a cover, said cover suitably adapted for attachment to said substrate;
providing a miniature tube according to claim 1, the terminal at least one of flanged and enlarged portion of said tube disposed within said recess;
said cover suitably adapted to receive said miniature tube through an opening defined within said cover; and
attaching said cover to said substrate so as to compressively seal said miniature tube within said recess.

8. The method of claim 7, further comprising the step of providing at least one of an o-ring and a gasket between said cover and said substrate.

9. The method of claim 8, wherein said at least one of a gasket and an o-ring is disposed between a peripheral portion of said cover and a peripheral portion of said substrate.

10. The method of claim 7, further comprising the step of providing a gasket between said miniature tube and said recess.

11. The method of claim 7, wherein said miniature tube comprises a first miniature tube, said first miniature tube comprising a fluid inlet; said method further comprising the steps of:
providing a second miniature tube;
providing a second recess in fluid communication with said flow field; and
providing a second opening defined within said cover, wherein said second tube comprises a fluid outlet.

12. The method of claim 7, further comprising the step flowing fluid through said miniature tube.

13. The method of claim 12, wherein said fluid temperature is between −50° C. and 300° C.

14. The method of claim 12, wherein said fluid pressure is between −1 atm and 3 atm.
